(19) United States
(12) Patent Application Publication
(10) Pub. No.: US 2025/0361873 A1
(43) Pub. Date: Nov. 27, 2025

(54) FAN WHEEL FOR A MOTOR VEHICLE

(71) Applicant: Brose Fahrzeugteile SE & Co. Kommanditgesellschaft, Wuerzburg, Wuerzburg (DE)

(72) Inventor: Christian FROH, Cuxhaven (DE)

(73) Assignee: Brose Fahrzeugteile SE & Co. Kommanditgesellschaft, Wuerzburg, Wuerzburg (DE)

(21) Appl. No.: 19/218,010

(22) Filed: May 23, 2025

(30) Foreign Application Priority Data
May 23, 2024 (DE) 10 2024 204 781.3

(51) Int. Cl. F04D 29/32; B60H 1/00; F04D 25/06

(52) U.S. Cl. CPC F04D 29/325; B60H 1/00464; F04D 25/06

(57) ABSTRACT

A fan wheel for a motor vehicle having a hub to which a number of sickled fan blades are connected, each having a front edge and a rear edge. At an end the blades are connected to an outer ring. A first angle is formed between the front edge and the outer ring, and a second angle is formed between the rear edge and the outer ring, whereby both angles are greater than 90°. A radiator fan for a motor vehicle is also provided.

This nonprovisional application claims priority under 35 U.S.C. § 119(a) to German Patent Application No. 10 2024 204 781.3, which was filed in Germany on May 23, 2024, and which is herein incorporated by reference.

### BACKGROUND OF THE INVENTION

### Field of the Invention

The invention relates to a fan wheel for a motor vehicle, having a hub to which a number of fan blades are connected. The fan wheel is preferably a component of a radiator fan of the motor vehicle. The invention further relates to a radiator fan for a motor vehicle, such as a main fan.

### Description of the Background Art

Motor vehicles with an internal combustion engine build up considerable heat during operation, so that the engine must be cooled. If the motor vehicle has an electric motor for propulsion, a high-voltage energy store is charged and discharged during operation, with heat losses occurring here as well, so that the high-voltage energy store must be cooled. For the cooling, and also for operation of an air conditioner, a liquid coolant/refrigerant is generally used which is then reheated. For recooling the coolant/refrigerant, a radiator network that is in heat exchange with the coolant/refrigerant and acted on by an airflow is typically used. For example, for this purpose the coolant/refrigerant is conducted in tubes that are incorporated into the radiator network. Since in particular at low vehicle speeds the airflow is normally not sufficient for the cooling, it is known to use an electric fan that intensifies the airflow or generates a corresponding wind.

The fan is typically situated behind the radiator network in the travel direction. By use of a fan wheel of the fan, air is then drawn through the radiator network and led to the internal combustion engine if necessary. At that location the air absorbs and removes excess heat of the internal combustion engine.

To achieve a comparatively high air volume flow rate through the radiator network, the fan wheel may be rotated at a comparatively high rotational speed. However, on the one hand it is possible for an air stream to split off. On the other hand, comparatively high-frequency vibrations thus occur which may be perceived as objectionable. Alternatively, it is possible to select a diameter of the fan wheel to be comparatively large, which, however, results in increased space requirements.

With the stated approaches, an increased application of force for rotating the fan wheel is also necessary. This requires a comparatively powerful electric motor, which results in increased manufacturing costs. One alternative therefore provides to sickle the fan blades so that they have a curved shape. This increases the length of the fan blades, but the radius of the fan wheel itself is not increased. It is thus also possible to rotate the fan wheel with a reduced torque. The fan blades are thus sickled only in the forward direction or backward direction, for example, which results in different advantages and disadvantages.

### SUMMARY OF THE INVENTION

It is therefore an object of the invention to provide a particularly suitable fan wheel for a motor vehicle and a particularly suitable radiator fan for a motor vehicle, in particular with an increase in performance and/or robustness and advantageous improvement of the acoustics.

In an example, the fan wheel in the installed state is preferably an integral part of a motor vehicle, and is suited and advantageously provided and configured for this purpose. In particular, the fan wheel in the installed state is a component of a radiator fan of the motor vehicle. The fan wheel is suited, in particular provided and configured, for drawing in or blowing air through a radiator of the motor vehicle. The radiator fan and thus also the fan wheel are preferably used to cool an internal combustion engine or a high-voltage energy store, such as a high-voltage battery, of the motor vehicle. A coolant/refrigerant is suitably cooled by means of the radiator, and/or an air stream is led to the internal combustion engine, which may be present, by means of the fan wheel. Alternatively, the fan wheel is, for example, a component of a blower which in particular conveys air into the interior of a motor vehicle. The motor vehicle is suitably land-based and is a passenger car, for example. Alternatively, the motor vehicle is a commercial vehicle, for example a truck or a bus.

The fan wheel can have an essentially flat design. However, at a minimum the extension of the fan wheel may be greater in one plane than in a plane perpendicular thereto. The fan wheel is suited, in particular provided and configured, for being rotated about a rotational axis. In particular, the rotational axis is perpendicular to the plane within which the fan wheel is situated. The fan wheel is preferably an axial fan wheel. During operation, air is thus moved along the rotational axis by means of the fan wheel. The diameter of the fan wheel is advantageously between 30 cm and 60 cm, between 40 cm and 50 cm, and for example essentially equal to 48 cm, with a respective deviation of 5 cm, 2 cm, or 0 cm advantageously being present.

The fan wheel itself can have a hub to which a number of fan blades are connected. The hub is suited, in particular provided and configured, for being fastened to an electric motor. In the installed state the electric motor which is possibly present is advantageously fastened to the hub, by means of which the fan wheel is rotated about the rotational axis. The hub is suitably situated concentrically with respect to the rotational axis, which reduces imbalance and thus decreases unwanted noise generation and excessive load. The hub preferably has an essentially cup-shaped design, with a cup base advantageously situated essentially perpendicular to the rotational axis. The fan blades are suitably connected at an outer circumference of a wall of the cup-shaped hub. If the hub has a cup-shaped design, the cup opening is advantageously open opposite from a possible air stream, in particular an airflow direction and/or a direction of motion of the motor vehicle. Air resistance is reduced in this way. Also, the cup opening can be open in the possible air stream. The hub advantageously has an essentially smooth design on the outside.

The fan blades, in particular also referred to as fan wheel blades, may have an identical design, which simplifies manufacture and installation. Each fan blade has a front edge and a rear edge, these being defined in particular based on the provided rotational direction of the fan wheel. The fan blades are, for example, angled/inclined with respect to the rotational axis. Each of the fan blades thus has a main direction of extension that is inclined with respect to the rotational axis. As a result, parallel to the rotational axis, i.e., in the axial direction, the front edge is offset relative to the rear edge of the particular fan blade. In particular a (setting) angle between 10° and 40° or between 15° and 30° is thus formed. Due to the inclination, during operation air moves in the axial direction, i.e., along the rotational axis or at least parallel thereto, by means of the fan wheel.

Each of the fan blades has, at least in part, an essentially radial course, in particular with respect to the rotational axis, so that the fan blades point outwardly from the hub. The fan blades have a curved design that advantageously forms a sickle shape. In other words, the fan blades are sickled. Thus, the radially outer end is offset, relative to the rotational axis, with respect to the radially inner end of the particular fan blade in the tangential direction. The directions in which all radially outer ends of the fan blades are offset are suitably identical.

The fan blades at the end, in particular at the radially outer end, are connected to an outer ring. The fan blades thus extend between the hub and the outer ring. The outer ring is advantageously concentric with respect to the possible rotational axis or at least preferably with respect to the hub. In particular, on the circumference the hub is surrounded by the outer ring at a distance. The fan blades are stabilized relative to one another via the outer ring. The outer ring, for example on the outside, preferably has a contour which in the installed state engages with other components of the motor vehicle, thus forming a labyrinth seal. The formation of an air leak is thus avoided.

A first angle is formed between the front edge and the outer ring. As a result, in the area of the connection of the particular fan blade to the outer ring the front edge has a profile that is tilted by the first angle relative to the tangential direction at that location. A second angle is formed between the rear edge and the outer ring. In other words, in the area of the connection to the outer ring the rear edge has the second angle relative to the tangential direction at that location.

Both the first angle and the second angle are greater than 90°. Thus, the front edge as well as the rear edge of each fan blade is connected to the outer ring to form an obtuse angle. In other words, an acute angle is not formed in the area of the connection of the two edges to the outer ring. A comparatively large connection surface is thus achieved between each fan blade and the outer ring, resulting in a stable connection and increased robustness. In addition, demolding is facilitated, thus simplifying manufacture. Furthermore, in the area of the outer ring a surface area of the fan blade is enlarged, so that a volume of air provided by the fan wheel during operation is increased without having to increase the rotational speed of the fan wheel or its diameter. The performance is thus increased. Due to the comparatively robust connection and the enlarged surface area, formation of undesirable vibrations is avoided, thus improving the acoustics.

For example, different first angles and second angles are associated with the different fan blades, these angles being greater than 90° in each case. However, all first angles and all second angles are particularly preferably equal. For example, the fan wheel has a rotationally symmetrical design, which simplifies the manufacture and design. In addition, alignment with other components of the motor vehicle is not necessary or is simplified, which facilitates installation. Alternatively, the angles formed between respective neighboring fan blades are different. Suitable formation of the air stream is thus made possible. For example, the fan wheel is made up of different components. However, the fan wheel particularly preferably has a one-piece design. The fan wheel is suitably made of a plastic, preferably by plastic injection molding. Manufacturing costs are thus reduced.

For example, the fan blades can be sickled backward. The radially outer ends of the fan blades are thus offset relative to the radial inner areas, opposite the rotational direction of the fan wheel. However, the fan blades are particularly preferably sickled forward. The radially outer ends of the fan blades are thus offset in the rotational direction of the fan wheel, and therefore to the front. The formation of undesirable air turbulence is thus prevented, and the acoustics are improved.

For example, the rear edges and the hub can be perpendicular to one another in each case in the area of the connection. Alternatively or in combination therewith, a 90° angle is formed in each case between the front edges and the hub in the area of the connection, so that the edges in each case exit the hub with formation of a right angle. Alternatively, this angle is greater than 90°. However, a smaller angle, which in particular is less than 70° and preferably less than 60°, is particularly preferably formed in each case between the rear edges and the hub. The angle is suitably greater than 30°, 40°, or 50°. The angle is advantageously essentially 55° or 45°. Thus, despite the acute angle a comparatively stable connection is present and manufacturing is not hampered. Alternatively or particularly preferably in combination therewith, an angle greater than 100° is formed in each case between each front edge and the hub, the angle preferably being less than 130° and preferably being 120°. Due to such a selection of the angles, in the area of exit from the hub each fan blade runs, essentially at least in part, opposite the rotational direction. In conjunction with the forward sickling, this results in a comparatively great length of the front edges and the rear edges, so that the effective length of the fan blades is increased. A conveyed air stream thus becomes increasingly larger, and hydraulic efficiency is improved. In one alternative, the angle formed between each front edge and the hub is less than 90°.

The first angle can be greater than 110° and in particular less than 180°. The first angle is preferably greater than 130° and in particular is between 150° and 160°. The first angle is suitably essentially 155°. A comparatively stable connection surface is thus present at the outer ring, and an arc length of the outer ring necessary for this purpose is not increased excessively.

The second angle can be between 120° and 170°. The second angle is suitably greater than 135° and particularly preferably between 140° and 160°. In particular, the second angle is essentially 145° or 155°. A comparatively stable connection surface is thus also present at the outer ring, and the arc length of the outer ring necessary for this purpose is not increased excessively.

For example, the first angle and the second angle of the particular fan blade can be different from one another. However, these angles are particularly preferably equal to one another. The two angles are advantageously between 150° and 160°. In particular, the first angle and the second angle are each essentially equal to 155°. Symmetry is thus provided, which results in improved acoustics and increases the stability.

For example, the front edge can have an undulated design. However, the front edge particularly preferably has a uniform curvature, and is thus curved in particular only on either the left side or the right side. In other words, the front edge has an essentially U- or C-shaped design. The second derivative of the front edge therefore has no change of algebraic sign. Such a design facilitates manufacture and increases robustness.

The curvature characteristic of the rear edge suitably changes at an inflection point. The rear edge is thus curved on both the left side and the right side. For example, the rear edge has an undulated design. However, the rear edge is particularly preferably S-shaped, so that the rear edge has only a single inflection point at which the curvature characteristic changes. Manufacturing is thus simplified, and the formation of undesirable air turbulence is avoided.

For example, the distance of the inflection point from the hub may be essentially one-half the distance between the hub and the outer ring, in particular the radial distance between the outer diameter of the hub and the inner diameter of the outer ring. Alternatively, the distance is smaller, or preferably greater. However, the distance of the inflection point from the hub is advantageously between 80% and 90% of the distance of the outer ring from the hub. Consequently, the curvature characteristic of the rear edge undergoes an inflection between 80% and 90%, advantageously at 85%, of the distance. The outer third of the particular fan blade has a significant effect on the hydraulic efficiency of the fan wheel. Due to the selection of the position of the inflection point, the rear edge is curved forward as well as backward in the area of significance, wherein the particular entire fan blade is sickled forward, in particular due to the design of the front edge. The advantages of forward sickling and backward sickling have a positive effect on the fan wheel, and the design is also simplified. In addition, demolding from a mold is facilitated.

At a distance of 75% of the distance of the outer ring from the hub, the front edge can have an angle between 100° and 110°, in particular 105°, with respect to the tangential direction. In contrast, the rear edge, in particular in this area, has an angle between 50° and 60°. The two edges are thus at least approximately parallel, for which reason a width of the fan blade does not vary excessively.

The radiator fan in the installed state can be an integral part of a motor vehicle, and is therefore suited as well as preferably provided and configured for installation on further components of the motor vehicle. The radiator fan advantageously serves to cool an internal combustion engine. In other words, the radiator fan is a main fan. Alternatively, the radiator fan is, for example, a component of an air conditioner or of an auxiliary unit of the motor vehicle. The radiator fan advantageously includes a radiator, which in particular has a radiator network through which preferably a number of tubes are led. The radiator network is, for example, thermally contacted with the tubes. A coolant/refrigerant such as a cooling fluid is preferably led inside the tubes during operation. The radiator network has an essentially cuboidal design, for example.

In addition, the radiator fan can include a fan shroud having a circular cutout. A fan wheel with a hub to which a number of sickled fan blades are connected is situated inside the circular cutout, advantageously parallel thereto and/or to the fan shroud. The fan blades each have a front edge and a rear edge, and at the end are connected to an outer ring. A first angle is formed between each front edge and the outer ring, and a second angle is formed between each rear edge and the outer ring. Both the first and the second angles are greater than 90°. The fan wheel is preferably situated concentrically with respect to the cutout.

In addition, the radiator fan can include an electric motor, which is a brushed commutator motor, for example, or preferably a brushless direct current (BLDC) motor. The electric motor is fastened to the fan shroud. For example, the fan shroud includes a motor mount that is held above the cutout via a number of mounting braces. A rotational axis of the electric motor is hereby situated perpendicular to the cutout, and extends in particular on the rotational axis of the fan wheel, preferably on a straight line that extends through the midpoint of the cutout. For example, the electric motor is adhesively bonded or screwed to the motor mount. The electric motor is thus held comparatively securely on the motor mount. The fan wheel is driven by the electric motor and is preferably connected thereto, for example to a shaft of the electric motor. For example, the hub is mechanically directly coupled to the electric motor.

In particular, the outer ring engages with a corresponding receptacle or contour of the fan shroud, the outer ring and the fan shroud preferably being spaced apart from one another. In particular, a labyrinth seal is formed between them, thus preventing spreading of leaked air. Alternatively or in combination therewith, a brush seal, rib structure, or the like is situated between the outer ring and the fan shroud.

The fan shroud can be connected, advantageously fastened, to the radiator. For example, the fan shroud can be screwed or adhesively bonded to the radiator. Alternatively, the fan shroud and the radiator are clipped or latched together, or the fan shroud is suspended on the radiator. In particular, the fan shroud overlays the radiator network that may be present. In other words, the fan shroud is congruent with the radiator network or the entire radiator, for example. Passage of air between the radiator and the fan shroud is thus prevented, and as a result the air is led comparatively efficiently by means of the fan shroud. The fan shroud is preferably situated downstream from the radiator, advantageously behind the radiator in the travel direction of the motor vehicle.

The advantages and refinements stated in conjunction with the fan wheel are analogously also transferred to the radiator fan, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle with a radiator fan,

FIG. 2 schematically shows a simplified exploded illustration of a portion of the radiator fan, together with a fan wheel that has multiple fan blades,

FIG. 3 shows a top view of a detail of the fan wheel, and

FIG. 4 shows a detail of an end area of one of the fan blades.

### DETAILED DESCRIPTION

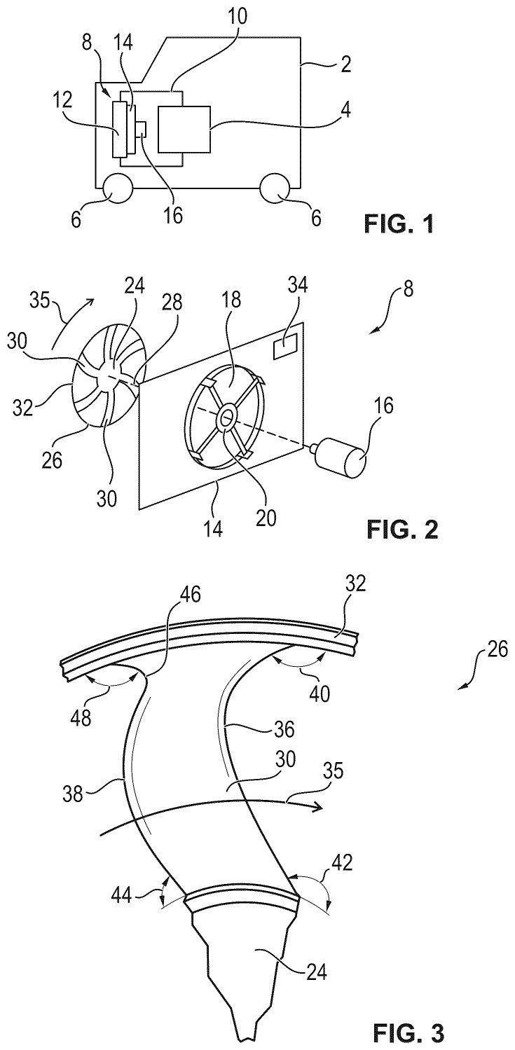

FIG. 1 schematically shows a simplified illustration of a motor vehicle 2 in the form of a passenger car having an internal combustion engine 4. The drive of the motor vehicle 2 takes place via the internal combustion engine 4. For this purpose, the internal combustion engine 4 is in operative connection with at least one of the four wheels 6 of the motor vehicle 2 by means of a drive train. In addition, the motor vehicle 2 includes a radiator fan 8 that is used to cool the internal combustion engine 4. The radiator fan 8 is thus a main fan of the motor vehicle 2. The radiator fan 8 is fluidically connected to the internal combustion engine 4 via a number of lines 10, through which during operation a cooling fluid is led from the radiator fan 8 to the internal combustion engine 4 and through cooling channels at that location. By means of the cooling fluid, excess heat is absorbed and led back to the radiator fan 8, via which cooling of the cooling fluid takes place.

The radiator fan 8 has a radiator 12 with a radiator network, through which a number of tubes are led and thermally contacted with the radiator network. The tubes are fluidically coupled to the lines 10, so that during operation the cooling fluid is led through the tubes. The radiator fan 8 also includes a fan shroud 14 that is situated behind the radiator 12 in a travel direction of the motor vehicle 2. An electric motor 16 designed as a brushless direct current (BLDC) motor is fastened to the fan shroud 14. During operation, airflow passes through the radiator 12 and is suitably shaped by means of the fan shroud 14. When the motor vehicle 2 is at a standstill, air is drawn in through the radiator 12 by means of the electric motor 16, so that during operation the air stream passes through the radiator 12 essentially continuously or at least as a function of existing requirements. Cooling of the radiator 12 thus takes place, so that even after a comparatively long operating period of the internal combustion engine 4 no overheating occurs. In addition, by means of the fan shroud 14 the air passing through the radiator fan 8 is led to the internal combustion engine 4, which is thus additionally cooled from the outside.

FIG. 2 shows a perspective, schematically simplified exploded illustration of the radiator fan 8 with the radiator 12 omitted. The fan shroud 14 is fastened to the radiator 12, and completely and congruently covers the radiator network. The fan shroud 14 has an essentially flat design, and has a circular cutout 18 that is oriented perpendicular to the travel direction 16 and has a diameter of 50 cm.

The fan shroud 14 also includes a motor mount 20, which is situated above the cutout 18, opposite the travel direction, and held there by means of multiple mounting braces 22. In the installed state the electric motor 16 is held by means of the motor mount 20, and the electric motor 16 is thus fastened thereto. The electric motor 16 is situated on the side of the fan shroud 14 opposite from the radiator 12. A shaft of the electric motor 16 protrudes through the motor mount 20 in the travel direction, and is rotatably fixedly fastened to a hub 24 of a fan wheel 26. The fan wheel 26 is thus driven by means of the electric motor 16, which is held by the motor mount 20.

The hub 24 has an essentially cup-shaped design and is situated concentrically with respect to a rotational axis 28 on which the shaft of the electric motor 16 lies, and which is specified by the shaft of the electric motor 16. The cup base of the hub 24 is situated perpendicular to the rotational axis 28, which also extends through the midpoint of the cutout 18. Radially outwardly extending fan blades 30 which are sickled are connected to the hub 24. The fan blades 30 thus have a tangential course, not a radial course, with respect to the rotational axis 28. At the radially outer end the fan blades 30 are fastened to an outer ring 32, which has an essentially hollow cylindrical or circular design. The outer ring 32 surrounds the hub 24 at a distance that is specified based on identical designs of the fan blades 30. The outer ring 32 is also situated concentrically with respect to the rotational axis 28. The entire fan wheel 26 has a one-piece design as a plastic injection-molded part. The individual components are also designed in such a way that the fan wheel 26 is rotationally symmetrical with respect to the rotational axis 28.

In the installed state, the fan wheel 26 is situated inside the cutout 18 in parallel with same, and during operation is rotated by means of the electric motor 18 about the rotational axis 28, which is parallel to the travel direction 16 and extends through the midpoint of the cutout 20. During operation, air is thus drawn in through the cutout 18, opposite the travel direction. The outer ring 32 rests in a corresponding contour of the fan shroud 14, thus forming a labyrinth seal. Passage of air between the fan wheel 26 and the fan shroud 14 is thus prevented. Due to the sickling of the fan blades 30, their radially outer ends are offset relative to the radially inner ends in a rotational direction 35. However, at least a portion of each fan blade is offset relative to the radially outer end, opposite the rotational direction 35. As a result, the fan blades 30 are sickled forward.

In addition, the fan shroud 14 includes a dynamic pressure flap 36, which has an opening that is covered by a flap. If a comparatively high (air) pressure prevails in front of the fan shroud 14 in the travel direction, in particular when the motor vehicle 2 is moving comparatively fast, passage of the air through the cutout 18 is partially hindered due to the fan wheel 26, or the fan wheel 26 would have to be rotated comparatively quickly. However, this would result in increased load on the electric motor 16 and the other components, and increased noise generation. Therefore, beginning at a certain pressure the flap is swiveled and the opening is freed up so that air can flow through it. Passage of air through the radiator 12, which is situated in front of the fan shroud 14 in the travel direction, is thus increased. For a comparatively low air pressure in front of the fan shroud 14, which is the case when the motor vehicle 2 is at a standstill, the flap is closed, thus preventing formation of a circular air stream that passes solely through the opening in the dynamic pressure flap 34 and the cutout 18. Thus, a sufficient air stream always passes through the radiator 12.

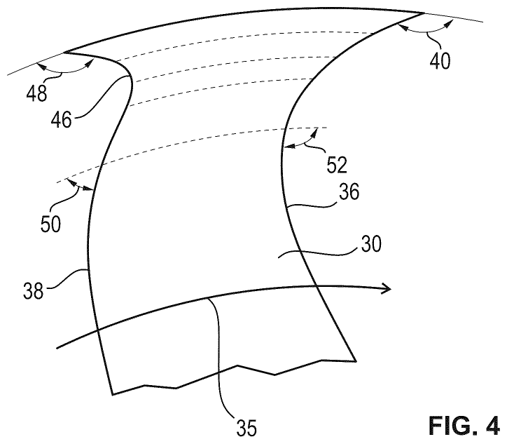

FIG. 3 shows a detail of the fan wheel 26 in a top view, i.e., along the rotational axis 28, with only one of the identically designed fan blades 30 being illustrated. FIG. 4 illustrates the end area of the fan blade 30, likewise in a top view. Each fan blade 30 has a front edge 36 and a rear edge 38. During rotation of the fan wheel 26, the rear edge 38 is moved in the direction of the front edge 36 of the same fan blade 30. The air stream may thus be generated by means of the fan wheel 26, the front edges 36 being offset relative to the rear edges 38 in the axial direction, i.e., parallel to the rotational axis 28.

The front edge 36 is essentially C-shaped and is thus uniformly curved. The curvature increases with the radial distance from the rotational axis 28, wherein the degree of the curvature changes, but not its algebraic sign. A first angle 40 is formed between the front edge 36 and the outer ring 32, which extends essentially tangentially. The first angle 40 is between 150° and 160°, namely, 156°. A (further) angle 42 of greater than 100°, for example 105° or 110°, is formed in the area of the exit from the hub 24, between the tangential direction at that location and the front edge 36. Due to such a design, each front edge 36, beginning at the end facing the hub 24, thus extends opposite the rotational direction 35, wherein due to the uniform curvature the front edge 36 then extends in the rotational direction 35 until it reaches the outer ring 32, where the first angle 40 is formed. The change from the course opposite the rotational direction 35 to the course in the rotational direction 35 takes place at a distance from the hub 24 that is 70% of the distance of the outer ring 32 from the hub 24.

The rear edges 38 do not have a uniform curvature characteristic. Thus, they exit from the hub 24 at an angle 44 that is less than 60°, so that the rear edges 38 also extend opposite the rotational direction 35. At a further distance from the hub 24, due to the curvature the rear edges 38 then extend in the rotational direction 35 until they reach an inflection point 46. At that location the curvature characteristic undergoes an inflection, and the rear edges 38 once again extend opposite the rotational direction 35 until they meet the outer ring 32 at a second angle 48. The second angle 48 is equal to the first angle 40, so that the former is between 150° and 160° and is 156°. All angles 40, 42, 44, 48 are determined in such a way that they lie outside the individual components of the fan wheel 26, and thus describe the course of the particular edge or the like outside the material of the fan wheel 26.

In summary, the rear edges 38 and the hub 24 thus each form the angle 44, which is less than 60° and is 45°, for example. In contrast, in the area of the transition the front edges 36 and the hub 24 form the angle 42, which is greater than 100° and is 105°, for example. The first angle 40, which is 156° and greater than 90°, is formed in each case between the front edges 36 and the outer ring 32. The second angle 48, which is likewise 156° and thus also greater than 90°, is formed between the rear edges 38 and the outer ring 32. In one alternative the second angle 48 is equal to 145° in each case.

The distance of the inflection point 46 from the hub 24 is 85% of the distance of the outer ring 32 from the hub 24. As a result, the inflection point 46 is radially offset comparatively far to the outside, so that in the area that is relevant for hydraulic efficiency the rear edge 38 extends opposite the rotational direction 35 and also in the rotational direction 35. The accompanying advantages are thus present, thereby improving the hydraulic efficiency of the fan wheel 26. Due to the inflection point 46 being set comparatively far to the outside, at 75% of the distance of the outer ring 32 from the hub 24 the rear edge 38 has a third angle 50, which is 54°, with respect to the tangential direction on the side of the hub 24. At this distance, a fourth angle 52 that is essentially 105° is formed between the front edge 36 and the tangential direction on the side of the hub 24.

The invention is not limited to the exemplary embodiment described above. Rather, other variants of the invention may also be derived by those skilled in the art without departing from the subject matter of the invention. In particular, all individual features described in conjunction with the exemplary embodiment may also be combined with one another in some other way without departing from the subject matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A fan wheel for a motor vehicle, the fan wheel comprising:
a hub to which at least two sickled fan blades are connected, each of the at least two sickled fan blades having a front edge and a rear edge, and at an end being connected to an outer ring,
wherein a first angle is formed between the front edge and the outer ring,
wherein a second angle is formed between the rear edge and the outer ring, and
wherein the first and second angles are greater than 90°.

2. The fan wheel according to claim 1, wherein the fan blades are sickled forward.

3. The fan wheel according to claim 2, wherein the rear edges and the hub in each case form an angle that is less than 60°, and wherein the front edges and the hub in each case form an angle that is greater than 100°.

4. The fan wheel according to claim 1, wherein the first angle is between 150° and 160°.

5. The fan wheel according to claim 1, wherein the second angle is between 140° and 160°.

6. The fan wheel according to claim 1, wherein the front edges are uniformly curved.

7. The fan wheel according to claim 1, wherein the curvature characteristic of the rear edges changes at an inflection point.

8. The fan wheel according to claim 7, wherein the distance of the inflection point from the hub is between 80% and 90% of a distance of the outer ring from the hub.

9. A radiator fan for a motor vehicle or a main fan of a motor vehicle, the radiator fan comprising:
the fan wheel according to claim 1; and
a fan shroud with a circular cutout, within which the fan wheel is arranged, and which is driven by an electric motor that is connected to the fan shroud.
